(19) United States
(12) Patent Application Publication
(10) Pub. No.: US 2020/0080884 A1
(43) Pub. Date: Mar. 12, 2020

(54) OUT-OF-POCKET DETECTION USING SENSORS AND BUBBLE COLLECTOR

(71) Applicant: Delaware Capital Formation, Inc., Wilmington, DE (US)

(72) Inventors: Terry Tincher, Lebanon, OH (US); Glen Shafer, Amelia, OH (US)

(21) Appl. No.: 16/555,308

(22) Filed: Aug. 29, 2019

Related U.S. Application Data
(60) Provisional application No. 62/727,766, filed on Sep. 6, 2018.

(51) Int. Cl. G01F 23/292

(52) U.S. Cl. CPC G01F 23/2921

(57) ABSTRACT

Apparatuses and methods for detecting an out-of-product condition in a chemical dispensing system. An optical sensor includes a photodetector and a light source configured to generate a beam of light. The light source is positioned such that the beam of light is incident on a supply line. A bubble collector is used to form an air pocket from a plurality of bubbles in the supply line generated by an out-of-product state. The supply line displaces the beam of light in dependence on the refractive index of a medium in the supply line, which is altered by the air pocket. The photodetector is positioned so that it is in the optical path of the displaced beam of light when the refractive index of the of the medium in the supply line is indicative of one of a product-available state or the out-of-product state.

### CROSS-REFERENCE TO RELATED APPLICATION

This application claims the benefit of and priority to U.S. Provisional Application No. 62/727,766 filed Sep. 6, 2018 (pending), the disclosure of which is incorporated by reference herein in its entirety.

### BACKGROUND

The invention generally relates chemical dispensing systems for laundry, ware-wash, and healthcare applications, and in particular, to systems, methods, and software products for detecting an out-of-product condition in a chemical dispensing system.

The dispensing of liquid chemical products from one or more chemical containers is a common requirement of many industries. For example, in an industrial laundry facility, each of several washing machines must be provided with aqueous solutions containing various quantities of alkaloid, detergent, bleach, starch, softener, and/or other chemical products.

The chemical products being dispensed are typically stored in containers with probe assemblies that monitor the level of products in the containers. Probe assemblies may detect the level of products in the containers using mechanical floats or electrical probes, for example. One type of probe assembly includes two probes separated by a distance so that the probe assembly has a high input impendence when exposed to air. Because the products are typically conductive to a certain extent, the input impendence of this type of probe assembly is lower when the probes are in contact with the product. To provide an indication of the level of product in a container, the probe assembly is mounted in the container so that the probes are in contact with the product, or the float causes a switch to be in a particular state (e.g., open or closed) when the container is sufficiently full.

When the level of product drops below the probes, the electrical probes are exposed to air, increasing the input impedance of the probe assembly, or the float drops sufficiently to change the state of the switch. To notify the operator of the chemical dispensing system that the container is running low on product, a monitoring device is connected to the probe assembly. In this type of detection system, the monitoring device is configured to detect the increase in the input impedance of the probe assembly or the change in the state of the switch, and may thereby notify an operator that the product is about to run out by providing an alarm.

Because these level monitoring systems rely on the measured input impedance of the probe assembly to detect the level of the product, anything that affects this measurement can have a negative impact on the reliability of the system. Likewise, the buildup of deposits on the float mechanism can impair the ability of the float to accurately detect the level of the product. Probe assemblies may experience reliability issues over time from the product attacking the probes due to the corrosive nature of many of the chemicals typically found in the product. Fouled or otherwise compromised probe assemblies and/or monitoring devices may cause erroneous readings. These erroneous readings may result in false alarms and/or failures to notify the operator that a product is running out. In addition, even if the level detection system is functioning correctly, pumps or other components that deliver the product may malfunction, thereby causing the chemical delivery system to fail to deliver product for reasons other than the supply of product running out.

To ensure products are being delivered to the machines fed by the chemical dispensing system, systems have been developed that monitor the flow of product to the machines. However, these systems typically rely on electrical sensors subject to the same failures as the level monitoring systems discussed above. Unreliable monitoring systems may result in the machines attached to the chemical dispensing system running without the required amounts of the chemical products being dispensed. The performance of the machines fed by the chemical dispensing system may be adversely affected due to too little of the product being dispensed, reducing the quality of machine's output and increasing expenses by requiring goods to be re-processed through the affected machine.

Therefore, there is a need for improved apparatuses and methods for monitoring the delivery of chemical products in chemical dispensing systems.

### SUMMARY

In an embodiment of the invention, an apparatus for detecting a low product condition in a chemical dispensing system is provided. The apparatus includes a detection tube, a light source configured to generate a beam of light having an optical path that passes through the detection tube, a photodetector that is in the optical path when the detection tube is in one of an out-of-product state or a product-available state, and is not in the optical path when the detection tube is in the other of the out-of-product state or the product-available state, and a bubble collector located in the detection tube and configured to modify movement of bubbles in the detection tube so that the bubbles form a pocket of air in the optical path.

In another embodiment of the invention, a method of detecting the low product condition in the chemical dispensing system is provided. The method includes directing the beam of light so that the optical path of the beam of light passes through the detection tube, modifying movement of bubbles in the detection tube using a bubble collector located in the detection tube so that the bubbles form the pocket of air in the optical path, and determining the detection tube is in one of the product-available state or the out-of-product state based on an electrical signal output by the photodetector that is in the optical path when the detection tube is in one of the out-of-product state or the product-available state and is not in the optical path when the detection tube is in the other of the out-of-product state or the product-available state.

The above summary may present a simplified overview of some embodiments of the invention to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an operating environment including an out-of-product detection module, and an optical sensor that monitors a supply line which supplies product to a machine.

FIG. 2A is a diagrammatic view of an exemplary optical sensor of FIG. 1 including a supply line in an out-of-product state.

FIG. 2B is a diagrammatic view of an exemplary optical sensor of FIG. 2A showing the supply line in a product-available state.

FIG. 3 is a diagrammatic view of a portion of the supply line in FIG. 2A showing refraction of a beam of light passing through the supply line.

FIG. 4 is an exploded perspective view of a detection unit that includes optical sensors having detection tubes in accordance with an embodiment of the invention.

FIG. 5 is a cross-sectional view of the detection unit of FIG. 4.

FIG. 6 is a cross-sectional view one of the detection tubes of FIG. 4 depicting a bubble collector.

FIG. 7 is an exploded perspective view of the detection tube of FIG. 6 showing additional details of the bubble collector.

FIG. 8 is a cross-sectional perspective view of the bubble detector of FIG. 7.

FIGS. 9 and 10 are cross-sectional views of one of the detection tubes of FIGS. 4 and 5 showing the bubble-collector in operation.

### DETAILED DESCRIPTION

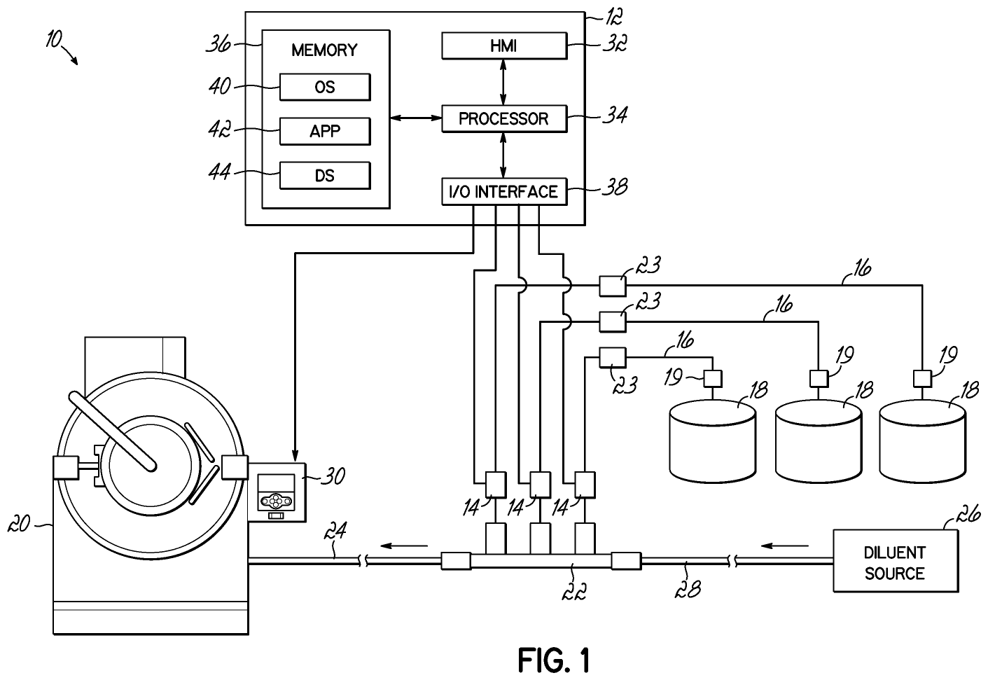

FIG. 1 depicts an operating environment for a chemical dispensing system 10 that includes an Out-Of-Product (OOP) detection module 12 in communication with one or more (e.g., three) optical sensors 14. Each of the optical sensors 14 may be optically coupled to a supply line 16 that fluidically couples a source of product 18 to a machine 20, such as a washing machine. A check valve 19 may be coupled to one or more of the supply lines 16 between the respective source of product 18 and the respective optical sensor 14. Each supply line 16, or a portion thereof, may comprise a tube of optically transparent material having an index of refraction n greater than that of air (e.g., of about 1.52) and couple a source of product 18 to the machine 20, such as via a flush manifold 22. One or more of the supply lines 16 may include a loop 23 between the source of product 18 and the optical sensor 14. The loop 23 may be configured to provide a small amount of resistance to the flow of product and facilitate formation of a pocket of air in the supply line 16, as will be described in more detail below. Examples of tubing suitable for use in the product supply lines may include Tygon® tubing, which is available from Saint-Gobain S.A. of Courbevoie, France.

For embodiments including the flush manifold 22, an output of the flush manifold 22 may be coupled to the machine 20 by a machine supply line 24, and an input of the flush manifold 22 may be coupled to a source of diluent 26, such as water, by a diluent supply line 28. Each source 18, 26 may selectively provide its product and/or diluent to the machine 20 in response to signals from a controller 30. The controller 30 may thereby control the amount and timing of product and/or diluent provided to the machine 20 by regulating the flow of the products and diluent through the flush manifold 22.

The detection module 12 may include a Human Machine Interface (HMI) 32, a processor 34, a memory 36, and an input/output (I/O) interface 38. The HMI 32 may include output devices, such as an alphanumeric display, a touch screen, and/or other visual and/or audible indicators that provide information from the processor 34 to a user. The HMI 32 may also include input devices and controls, such as an alphanumeric keyboard, a pointing device, keypads, pushbuttons, control knobs, etc., capable of accepting commands or input from the user and transmitting the entered input to the processor 34. By way of example, the input and output devices of HMI 32 may include a membrane overlay with embedded Light Emitting Diodes (LEDs) and buttons.

The processor 34 may include one or more devices configured to manipulate signals (analog or digital) based on operational instructions that are stored in memory 36. Memory 36 may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, or any other device capable of storing information. Memory 36 may also include a mass storage device (not shown), such as a hard drive, optical drive, tape drive, non-volatile solid state device, or any other device capable of storing digital information.

Processor 34 may operate under the control of an operating system 40 that resides in memory 36. The operating system 40 may manage detection module resources so that computer program code embodied as one or more computer software applications 42 residing in memory 36 may have instructions executed by the processor 34. In an alternative embodiment, the processor 34 may execute the applications 42 directly, in which case the operating system 40 may be omitted. One or more data structures 44 may also reside in memory 36, and may be used by the processor 34, operating system 40, and/or application 42 to store data.

The I/O interface 38 operatively couples the processor 34 to other components in the dispensing system 10, such as the optical sensors 14 and/or controller 30. The I/O interface 38 may include signal processing circuits that condition incoming and outgoing signals so that the signals are compatible with both the processor 34 and the components to which the processor 34 is coupled. To this end, the I/O interface 38 may include analog to digital (A/D) and/or digital to analog (D/A) converters, voltage level and/or frequency shifting circuits, optical isolation and/or driver circuits, and/or any other analog or digital circuitry suitable for coupling the processor 34 to the other components of the dispensing system 10. In particular, the I/O interface 38 may include a multiplexer that selectively couples individual optical sensors 14 to the processor 34. Selective coupling may include sequentially coupling each of one or more active detector inputs of the I/O interface 38 to the processor 34 so that the processor 34 can receive electrical signals from and/or provide electrical signals to the optical sensors 14. This feature may enable the processor 34 to selectively activate and/or monitor a plurality of optical sensors 14 using a single input/output port and/or A/D converter. The I/O interface 38 may also include one or more amplifiers that amplify voltages provided by the optical sensors 14 to a level suitable for use by the A/D converter.

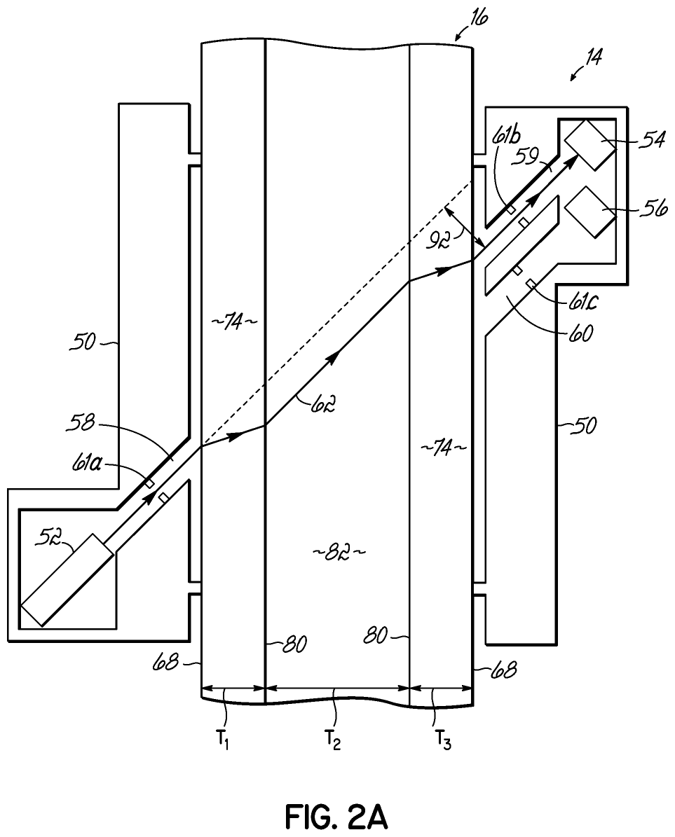

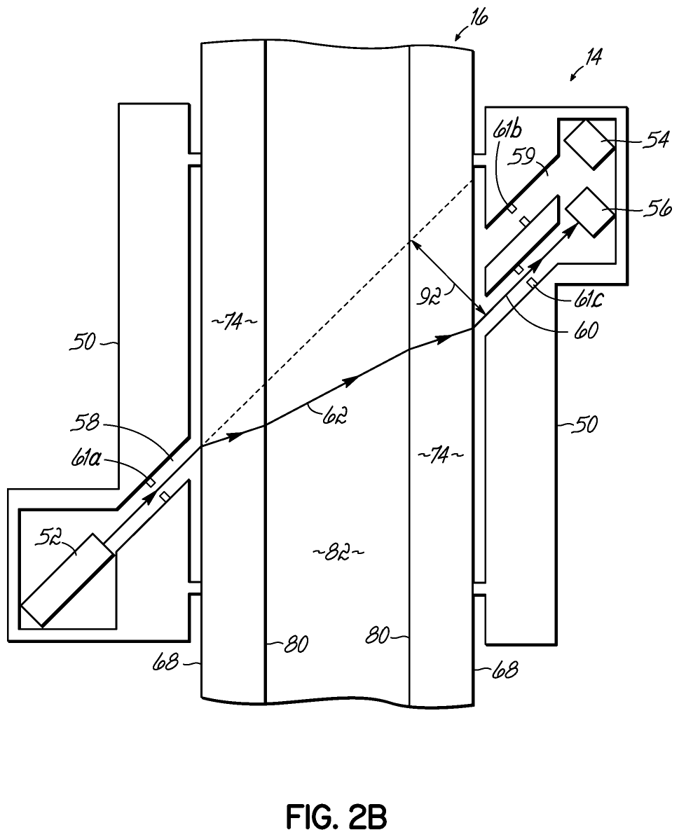

FIGS. 2A and 2B depict an optical sensor 14 in accordance with an embodiment of the invention that includes a holder 50, a light source 52, and one or more (e.g., two) photodetectors 54, 56. The holder 50 may be configured to locate the light source 52 and photodetectors 54, 56 in a fixed position relative to the supply line 16. The holder 50 may include one or more channels 58-60 that provide one or more optical paths for a beam of light 62 emitted by the light source 52. Each of the channels 58-60 coupling the light source 52 and photodetectors 54, 56 to the supply line 16 may include an aperture 61a-61c that defines an opening having a predetermined size and shape. For example, the source channel 58 may include a circular aperture 61a having a diameter of 2 mm or less, and the photodetector channels 59, 60 may each include a circular aperture 61b, 61c having a diameter of 3 mm or less. In an alternative embodiment of the invention, the apertures may be rectangular (e.g., slots) rather than circular. The apertures 61a-61c may be defined by baffles formed in the channel 58-60 as depicted in FIGS. 2A and 2B, or by the cross-sectional shape of the channel 58-60 itself. The apertures 61a-61c may be configured to allow the beam of light 62 to reach one or the other of the photodetectors 54, 56 when the medium 82 in supply line 16 (or some other transparent tube) has a refractive index n specific to that photodetector (e.g., n=1.3 or 1.0), and may shield the photodetectors 54, 56 from the beam of light 62 when the medium 82 in the supply line 16 has a different refractive index.

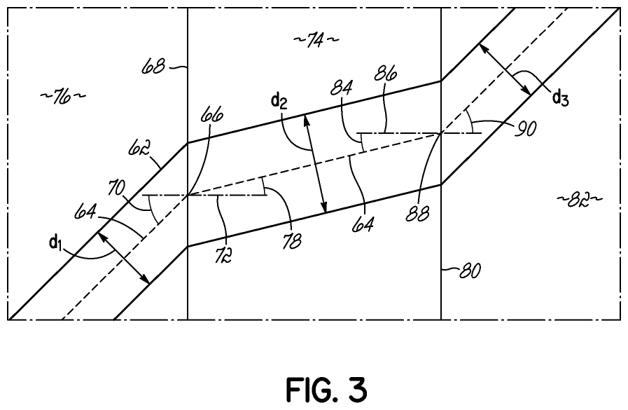

Referring now to FIG. 3, and with continued reference to FIGS. 2A and 2B, the light source 52 may be positioned by the holder 50 so that a centerline 64 of beam of light 62 is centered on a point of incidence 66 on an outer surface 68 of supply line 16. The beam of light 62 may have an angle of incidence 70 relative to a line 72 normal to the outer surface 68 at the point of incidence 66. The angle of incidence 70 may be an oblique angle (e.g., 45 to 70 degrees). For a supply line 16 comprised of a medium 74 having an index of refraction different than the medium 76 through which the beam of light 62 passes before encountering the outer surface 68, the beam of light 62 is refracted so that it assumes an angle of emittance 78 relative to line 72.

The relationship between the angle of incidence 70 and the angle of emittance 78 is governed by Snell's law:

$$\frac{{n}_{1}}{{n}_{2 }} = \frac{sin ( {θ}_{2} )}{sin ( {θ}_{1} )} \qquad Eqn . 1$$

where n₁ is the refractive index of the medium 76 external to the supply line 16, n₂ is the refractive index of the medium 74 of supply line 16, θ₁ is the angle of incidence 70, and θ₂ is the angle of emittance 78. Solving equation 1 for the angle of emittance 78 yields:

$${θ}_{2} = arcsin ( \frac{{n}_{1} \times sin ( {θ}_{1} )}{{n}_{2}} ) \qquad Eqn . 2$$

A similar effect may be observed as the beam of light 62 crosses the inner surface 80 of supply line 16 and encounters the medium 82 in supply line 16. The transition from the medium 74 of supply line 16 to the medium 82 in supply line 16 may be determined by Equation 3:

$${θ}_{4} = arcsin ( \frac{{n}_{2} \times sin ( {θ}_{3} )}{{n}_{3}} ) \qquad Eqn . 3$$

where n₃ is the refractive index of the medium 82 in supply line 16, θ₃ is an angle of incidence 84 relative to a line 86 normal to the inner surface 80 of supply line 16 at a point of incidence 88, and θ₄ is the angle of emittance 90 of the beam of light 62. For embodiments in which the line 86 normal to inner surface 80 is parallel to the line 72 normal to outer surface 68, and the refractive indexes of the media 76, 82 are equal, the angle of incidence 84 may be equal to the angle of emittance 78.

When the beam of light 62 crosses the boundary between mediums (e.g., the boundary between air and a polymer) defined by outer surface 68, the velocity of the beam of light 62 may be altered (e.g., reduced). This change in velocity may cause the beam of light 62 to be refracted towards (in the case of a reduction in velocity) or away (in the case of an increase in velocity) from the line 72 normal to surface 68 at an angle based on the refractive indices of the mediums 74, 76. Indeed, the path of the beam of light 62 may be altered each time it encounters a boundary between any of the medium 76 external to supply line 16, the medium 74 of supply line 16, and the medium 82 in supply line 16. This bending may produce a total lateral shift 92 in the beam of light 62 that is dependent in part on the index of refraction n₃ of the medium 82 in the supply line 16. The total lateral shift 92 may be the sum of each lateral shift the beam of light 62 experiences as it propagates from the light source 52 to the photodetectors 54, 56. The total lateral shift 92 introduced over the optical path of beam of light 62 may be determined using Equation 4:

L_{S}=ΣTₘ×sec(θᵣ)×sin(θᵢ−θᵣ) Eqn. 4

where L_{S} is the total lateral shift, Tₘ is a thickness (e.g., T₁, T₂, T₃) of each layer of medium (e.g., mediums 74, 76, 82) through which the beam of light 62 passes, θᵢ is the angle of incidence at each respective boundary, and θᵣ is the angle of refraction at each respective boundary.

The energy level of the beam of light 62 may be altered as it propagates over the optical path due to the optical properties of the various media. For example, a certain amount of light may be lost at each boundary due to reflection and diffusion. A lateral dimension d of the beam of light 62 (e.g., d₁, d₂, d₃) may also be altered due to refraction at each boundary. For example, the cross-sectional area of the beam of light 62 may increase or decrease in one dimension. This expansion or contraction of the dimension d may be determined using Equation 5:

$$\frac{{d}_{r}}{{d}_{i}} = \frac{cos ( {θ}_{r} )}{cos ( {θ}_{i} )} \qquad Eqn . 5$$

where dᵢ is the dimension of the incident beam, and dr is the dimension of the refracted beam. Other conditions that may alter the energy level and/or path of the beam of light 62 may include scattering or absorption of light by the medium 82, e.g., due to particulates suspended in the medium 82.

A portion of the beam of light 62 may also be reflected at each boundary, thereby reducing the power of the refracted beam. To satisfy the law of conservation of energy, the total power of the refracted and reflected portions of the beam must equal the power of the incident beam. The power of the refracted beam as a fraction of the incident power, or transmittance T, is provided by Equation 6:

$$T = \frac{{n}_{r} \times cos ( {θ}_{r} ) \times {\vert {E}_{r} \vert}^{2}}{{n}_{i} \times cos ( {θ}_{i} ) \times {\vert {E}_{i} \vert}^{2}} = \frac{{n}_{r} \times cos ( {θ}_{r} )}{{n}_{i} \times cos ( {θ}_{i} )} \times {\vert t \vert}^{2} \qquad Eqn . 6$$

where Eᵣ is the amplitude of the electric field of the refracted beam of light, Eᵢ is the amplitude of the incident beam of light, nᵣ is the refractive index of the medium in which the refracted beam of light is propagating, nᵢ is the refractive index of the medium in which the incident beam of light is propagating, and t is a coefficient equal to the ratio of the amplitude of the electric field of the transmitted beam of light to the amplitude of the electric field of the incident beam of light.

The detection module 12 and/or optical sensors 14 may be configured to determine the presence or absence of product in the supply lines 16 based on these refraction ratios and the lateral shifts 92 produced by interaction of the different indexes of refraction with the beam of light 62. The holder 50 of optical sensor 14 may be configured to position the light source 52 and/or photodetectors 54, 56 so that the amount of energy transferred from the light source 52 through the various media 74, 76, 82 is optimized for reliable detection in view of the angles of refraction and the widening or narrowing of the beam of light 62 across the optical path. This optimization may provide the detection module 12 with a robust signal that enables the module to accurately determine the presence or absence of product in the supply line 16. This signal may be, for example, a voltage output by one or more of the photodetectors 54, 56 indicative of the presence, absence, and/or intensity of the beam of light 62 at the respective photodetector 54, 56.

Although the exemplary optical sensor 14 depicted by FIGS. 2A and 2B includes two photodetectors 54, 56, embodiments of the invention may include optical sensors 14 that have a single photodetector, or more than two photodetectors. Optical sensors 14 may be configured so that the presence of product in the monitored supply line 16 causes the beam of light 62 to be directed to a photodetector (in which case the presence of light at the photodetector would indicate the presence of product in the supply line 16), or away from a photodetector (in which case the presence of light at the photodetector would indicate an absence of product in the supply line 16). Multiple photodetectors in different locations may also be used to determine a type of product in the supply line 16 based on the lateral shift 92 of beam of light 62 caused by differences in the refractive indexes of different products.

The light source 52 may be configured to emit a wavelength of between 900 and 1100 nm, although other wavelengths may also be used. A suitable device that may be used as the light source might include an LED that emits Infrared (IR) light having a wavelength of about 940 nm, for example. The wavelength of the light source 52 may be selected to be one for which the supply line 16 has a high transmittance. For example, it has been determined that model 2735 type of Tygon® tubing has good transmissivity at wavelengths greater than 900 nm with little absorbance of energy.

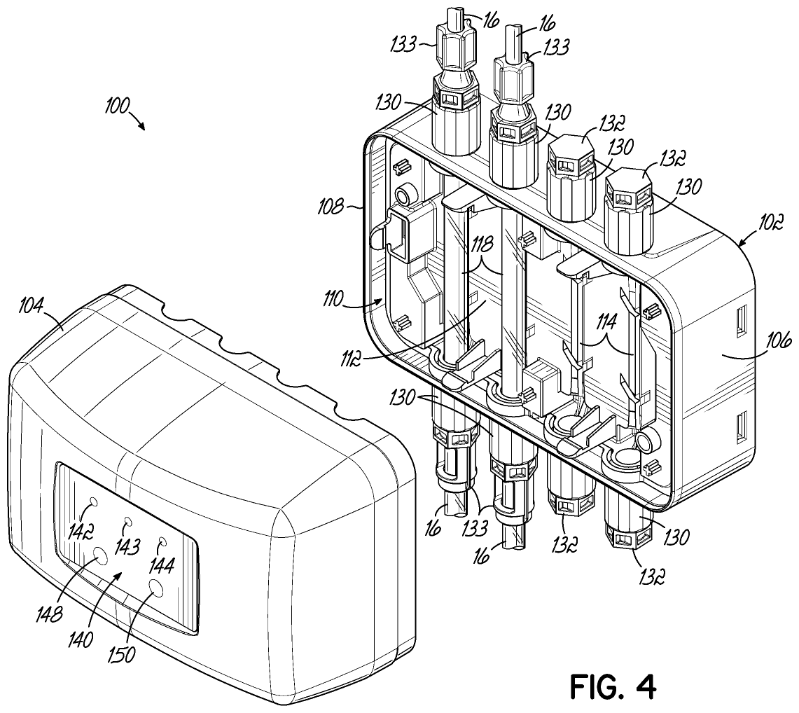

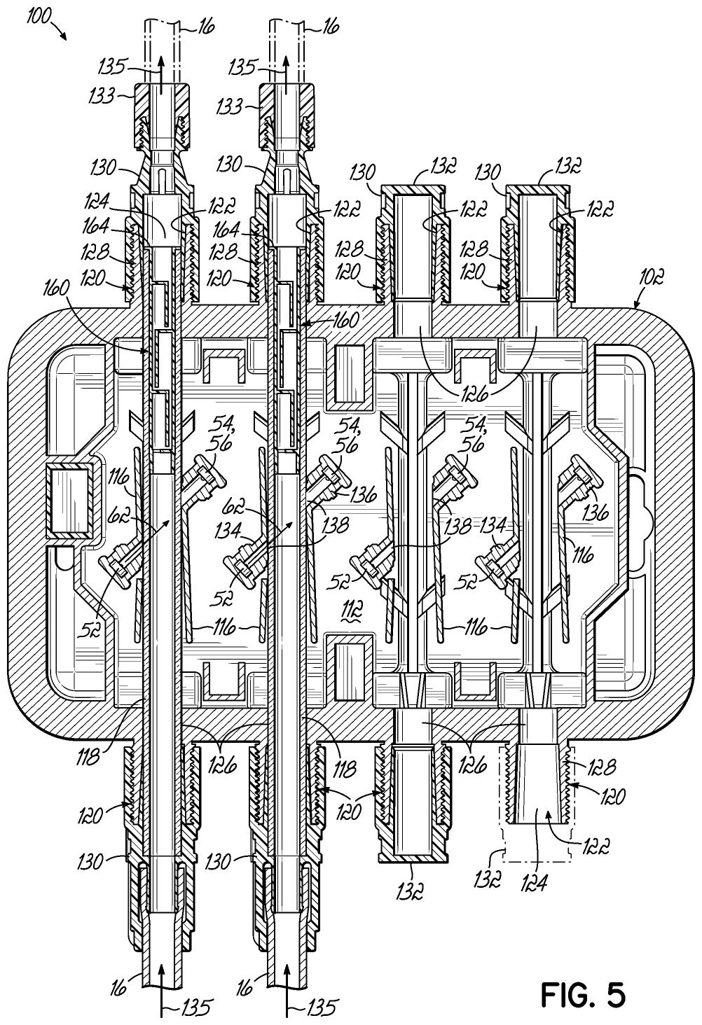

FIGS. 4 and 5 present a perspective view and a cross-sectional view, respectively, of a detection unit 100 that includes one or more optical sensors 14 in accordance with an embodiment of the invention. The detection unit 100 comprises a base 102 and a cover 104. The base 102 includes a generally rectangular sidewall 106 having an edge 108 at the top thereof that defines the perimeter of an opening 110, and a backwall 112 opposite the opening 110 from which one or more (e.g., four) supports 114 and/or guides 116 project toward the opening 110. The supports 114 and/or guides 116 may be configured to receive and locate one or more detection tubes 118 relative to the base 102. Each detection tube 118 may be considered to be part of the supply line 16 to which it is coupled.

The sidewall 106 may include a plurality of connectors 120 arranged in one or more pairs on opposing sides of sidewall 106. Each connector 120 includes a passage 122 that connects an outer opening 124 of connector 120 to an inner opening 126 of connector 120. The connector 120 may include a threaded cylindrical protrusion 128 configured to receive a fitting 130. The fitting 130 may be configured to fluidically couple the supply line 16 and/or a cap 132 to the outer opening 124 of connector 120, e.g., using a coupling mechanism 133 such as a quick coupler, a compression coupler, or the like. The inner opening 126 may be configured to receive one end of a respective detection tube 118 and provide a fluid-tight connection that fluidically couples the end of the detection tube 118 to the outer opening 124.

Each pair of connectors 120 may be aligned along a direction of flow 135 so that the detection tube 118 coupling the inner openings 126 of opposing connectors 120 traverses the base 102 along a generally linear path defined by the supports 114 and/or guides 116. For embodiments including more than one pair of connectors 120, the connectors 120 may be arranged so that the detection tubes 118 are generally parallel to each other.

When the detection unit 100 is assembled, each detection tube 118 may be straddled by diagonally aligned chambers 134, 136. Each of the chambers 134, 136 may be configured to enclose a respective one of the light source 52 or one or more photodetectors 54, 56. The diagonally aligned chambers 134, 136 may each include a respective aperture 138 configured to provide an optical path between the respective light source 52 and photodetector(s) 54, 56 that passes through the detection tube 118. Although the light source 52 is shown as being in the lower chamber 134 and the one or more photodetectors 54, 56 are shown as being in the upper chamber 136, embodiments of the invention are not limited to the depicted configuration. For example, the light source 52 may be in the upper chamber 136, in which case the one or more photodetectors 54, 56, would be in the lower chamber 134. The horizontal alignment of the diagonally aligned chambers 134, 136 could also be reversed from that depicted in FIG. 5 without materially affecting operation of the detection unit 100.

The cover 104 may include a display panel 140 having one or more (e.g., three) indicators 142-144 and one or more (e.g., two) input devices 148, 150 (e.g., an enable button and a mute button) for controlling operation of the detection module 12. The indicators 142-144 may be selectively activated and deactivated by the detection module 12 to provide an indication to the user of whether an out-of-product condition has been detected and/or other information regarding operation of the detection unit 100. In an embodiment of the invention, the number of indicators 142-144 may match the number of optical sensors 14 in the detection unit 100.

As product begins to run out, the product may be replaced with pockets of air in portions of the detection tube 118. These pockets of air may change the refractive index n of the material in the supply line detection tube 118. This change in the refractive index n may alter the characteristics of the optical path(s) between the light source 52 and one or more photodetectors 54, 56 of the optical sensor 14. This change in the characteristics of the optical path may affect the intensity of the light at one or more photodetectors 54, 56 by bending the beam of light 62 towards or away from the respective aperture coupling the beam of light 62 to the photodetector 54, 56. Pockets of air in the detection tube 118 may thereby cause the beam of light 62 to be directed towards (or away) from the respective aperture 138. The resulting change in the intensity of the light detected by the photodetector 54, 56 may provide an indication of an out-of-product condition to the detection module 12.

The detection module 12 may determine the intensity of the light at each photodetector 54, 56 being monitored, and compare this intensity to an expected intensity. The expected intensities for normal operation and an out-of-product condition may depend on whether the optical sensor 14 is configured to direct the beam of light 62 toward or away from the photodetector in the presence or absence of product in the detection tube 118. Based on this comparison, the detection module 12 may determine if the product is running out. In response to detecting an out-of-product condition, the detection module 12 may alert the user. This determination may be triggered by an absence of product in the detection tube 118 between the light source 52 and the one or more photodetectors 54, 56 of the optical sensor 14.

Operation of the optical sensor 14 may rely on the solution in the detection tube 118 being displaced with pockets of air that are drawn from the source of product 18 when the product runs low. In some cases, the dispensing system 10 may fail to pull enough air from the source of product 18 during a low product condition to completely displace the product in the detection tube 118. This failure to draw air into the detection tube 118 may reduce the reliability of the optical sensor 14 in some situations.

For example, a lack of sufficient air in the detection tube 118 may occur in cases where a continuously running low RPM peristaltic pump is dispensing products to a conveyorized ware washing machine. Because the detection tube 118 in this exemplary scenario may have a larger diameter than the output discharge tube connected to the rinse port of the ware washing machine, the resulting fluid dynamics may produce bubbles of air having a diameter significantly smaller than the inside diameter of the supply line 16 and/or detection tube 118. Instead of forming a solid column or pocket of air, these small bubbles may stream up the center of the supply line 16 and/or detection tube 118 as the source of product 18 is drawn into the input port of the peristaltic pump.

Thus, in the above described scenario where the optical sensor 14 is located between the source of product 18 and the input port of the peristaltic pump, even though the source of product 18 is low, the evacuation of the product in the supply line 16 may not behave as expected due to the low flow rate of product through the supply line 16. In certain cases, this phenomenon may prevent the optical sensor 14 from seeing enough of a change in refractive index n in a short enough period of time to trigger an effective low product warning when the supply line 16 and/or detection tube changes from a normal product-available state (sometimes referred to as a “wet state”) to an out-of-product state (sometimes referred to as a “dry state”).

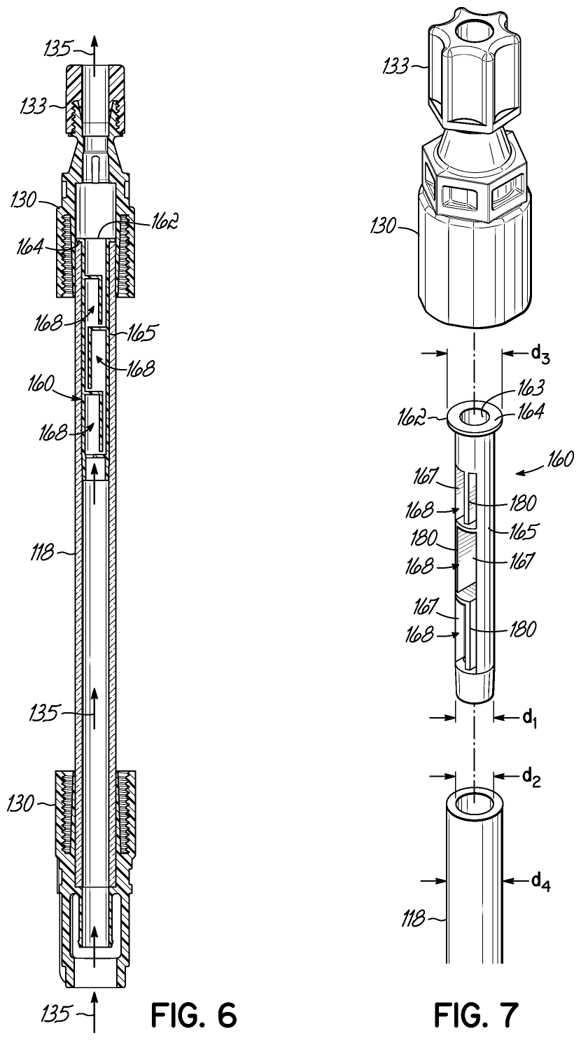

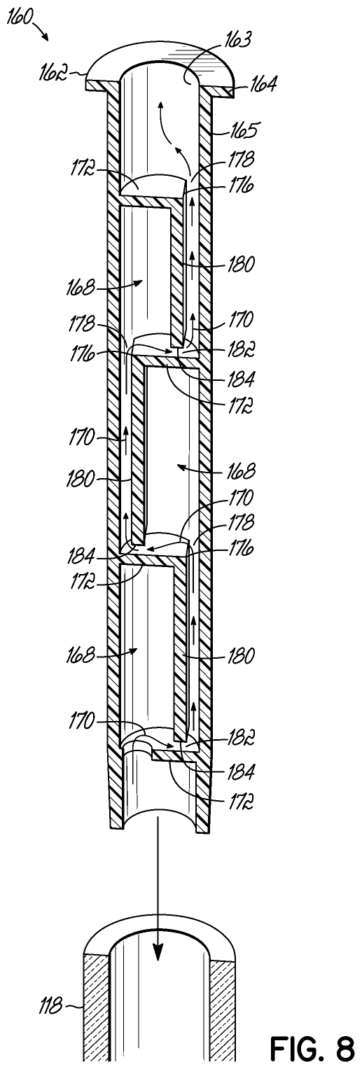

As best shown in FIGS. 6-8, and with continued reference to FIG. 5, to increase the sensitivity of the optical sensor 14 to detection of small bubbles, a bubble collector 160 may be placed in the detection tube 118 proximate to where the beam of light 62 passes through the detection tube 118. The bubble collector 160 may comprise a generally hollow device including a generally cylindrical shell 161 having an inner surface 163, an outer surface 165, and one or more side openings 167. The outer surface 165 may be configured to locate the bubble collector 160 laterally with respect to the inner surface of detection tube 118. To this end, the bubble collector 160 may have an outside diameter d₁ equal to or slightly less than an inside diameter d₂ of the detection tube 118 so that the bubble collector 160 can be inserted into the detection tube 118.

The bubble collector 160 may be configured so that a top end 162 thereof is held in place within the passage 122 of connector 120 by the fitting 130. To this end, the bubble collector 160 may include a flange 164 that extends radially outward from the top end 162 of bubble collector 160. The flange 164 may have an outer diameter d₃ larger than the inner diameter d₂ of detection tube 118. The flange 164 may thereby define an insertion depth of the bubble collector 160 lengthwise into the detection tube 118 by resisting insertion of the bubble collector 160 beyond a point at which the flange 164 contacts the end of detection tube 118.

The outer diameter d₃ of flange 164 may be the same as or slightly less than an outer diameter d₄ of detection tube 118. This may allow the flange 164 to be urged into contact with the end of detection tube 118 by the fitting 130 as the fitting 130 is fastened onto the threaded cylindrical protrusion 128. In an alternative embodiment, the outer diameter d₃ of flange 164 may be larger than the outside diameter of detection tube 118 so that the flange 164 is urged into contact with a shoulder or other feature (not shown) within the passage 122 of connector 120 by the fitting 130.

The bubble collector 160 may include one or more chambers 168 arranged to create a torturous path 170 through the bubble collector 160. Each chamber 168 may include a partition 172 that extends from a portion of the inner surface 163 of bubble collector 160 to define a portion of the bubble collector 160 occupied by the chamber 168. The side openings 167 and chambers 168 may be arranged so that a user can view a buildup of air in the chambers 168 and/or to allow the beam of light 62 to pass through one of the chambers 168. In an alternative embodiment of the invention, the bubble collector 160 may be formed from a material that is transparent to visible light and/or the beam of light 62, in which case the side openings 167 may be omitted.

Each partition 172 may include an edge 176 that defines an opening 178 between the partition 172 and another portion of the inner surface 163 generally opposite from the edge 176. In an alternative embodiment of the invention, the opening 178 in one or more of the partitions 172 (e.g., the lowest partition) may be defined by an aperture in the partition 172 rather than a gap between the edge 176 of partition 172 and the inner surface 163 of shell 161. A baffle 180 may extend at an angle (e.g., perpendicularly downward) from the edge 176 of each partition 172. A lengthwise spacing of the partitions 172 along the bubble collector 160 and the lengths of the baffles 180 may be configured to leave a gap 182 between a distal end 184 of the baffle 180 and a partition 172 adjacent to the baffle 180. The openings 178 defined by partitions 172 may be angularly offset from each other so that the openings 178 defined by sequential partitions 172 are vertically misaligned. For example, each partition 172 may be rotated 180 degrees relative to its adjacent partitions 172 so that the openings 178 occupy alternating sides of the cross-sectional shape of the detection tube 118.

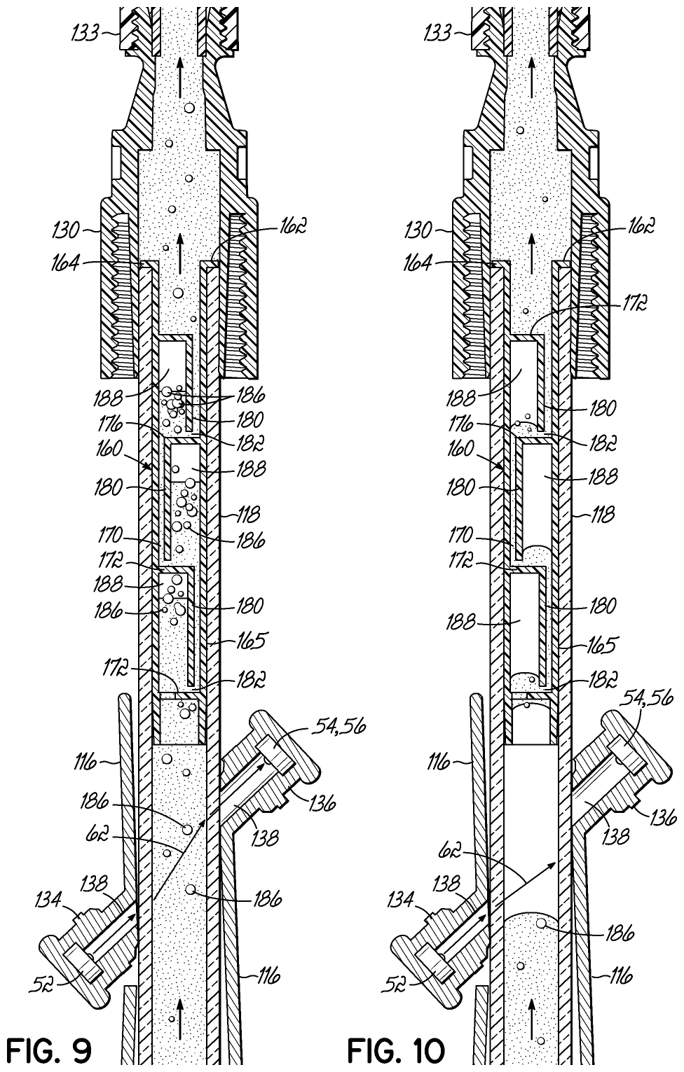

Referring now to FIGS. 9 and 10, in operation, a stream of bubbles 186 may pass through the detection tube 118 and bubble collector 160 by traveling along the tortuous path 170. As the bubbles 186 pass through the bubble collector 160, they may tend to collect in a portion of the detection tube 118 below the bubble collector 160 as well as in the chambers 168 of bubble collector 160. As a result, a portion of the bubbles 186 may come into contact with each other and merge to create pockets of air 188 in the solution flowing through the detection tube 118 and bubble collector 160. After a short period of time, the merging bubbles 186 may create one or more relatively large pockets of air 188 that essentially fills one or more chambers 168 and/or a portion of the detection tube 118 below the bubble collector 160 which is in the path of the beam of light 62. This pocket of air 188 may deflect the beam of light 62 to a sufficient extent to allow the optical sensor 14 to detect the low product condition which is generating the stream of bubbles 186.

The elements of the bubble collector 160 that define the torturous path 170 may be configured so that the torturous path 170 does not create enough of a restriction to the flow of product to significantly reduce the flow of product through the detection tube 118 in normal operation. In an embodiment of the invention, the length of the bubble collector 160 may be selected so that the bubble collector 160 does not interfere with the optical path of the beam of light 62 during normal operation, but creates a collection point for a pocket of air 188 in the detection tube 118 below the bubble collector 160.

When present, the loop 23 may facilitate operation of the bubble collector 160 by providing resistance to the flow of product and/or a collection point for the bubbles 186. The loop 23 may comprise, for example, a U-shaped portion of supply line 16 oriented so that the bottom of the U-shape is located at a low point below the optical sensor 14 and/or the source of product 18. In an embodiment of the invention, the loop 23 may be located proximate to the source of product 18. The loop 23 may create a small amount of resistive pressure to help in the process of accumulating pockets of air 188 in the supply line 16 by defining a path that drops from the source of product 18 to the low point and then travels on an upward path from the bottom of the loop to the detection unit 100.

In an embodiment of the invention, the source of product 18 may include a chemical container having an inline check valve. For sources of product 18 that do not include a closed container cap (e.g., that allow air into the container as product is consumed), the check valve 19 may be added to the supply line 16 to prevent product from draining out of the supply line 16 between dispense cycles, which could cause a false out-of-product alarm.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An apparatus for detecting a low product condition in a chemical dispensing system, the apparatus comprising:
a detection tube;
a light source configured to generate a beam of light having an optical path that passes through the detection tube;
a photodetector that is in the optical path when the detection tube is in one of an out-of-product state or a product-available state, and is not in the optical path when the detection tube is in the other of the out-of-product state or the product-available state; and
a bubble collector located in the detection tube and configured to modify movement of bubbles in the detection tube so that the bubbles form a pocket of air in the optical path.

2. The apparatus of claim 1 wherein the bubble collector comprises:
a cylindrical shell having a length and including a bottom opening and a top opening offset from the bottom opening.

3. The apparatus of claim 2 wherein the cylindrical shell includes a side opening in a side of the cylindrical shell.

4. The apparatus of claim 3 wherein the side opening is in the optical path.

5. The apparatus of claim 2 wherein the bubble collector further comprises one or more chambers in the cylindrical shell that fluidically couple the bottom opening to the top opening.

6. The apparatus of claim 5 wherein the bubble collector further comprises one or more partitions that project from an inner surface of the cylindrical shell, each partition defining an end of at least one of the one or more chambers.

7. The apparatus of claim 6 wherein the one or more partitions include at least two partitions positioned sequentially along the length of the cylindrical shell, and the one or more chambers are located between the at least two partitions.

8. The apparatus of claim 7 wherein the bubble collector further comprises one or more baffles each extending lengthwise from an edge of a respective one of the one or more partitions and having a length that leaves a gap between a distal end of the baffle and the partition adjacent to the partition from which the baffle extends.

9. The apparatus of claim 8 wherein the edge of each partition defines an opening at one end of at least one of the one or more chambers, and each opening is rotationally offset from any adjacent openings so that the one or more partitions and the one or more baffles define a torturous path through the bubble collector.

10. The apparatus of claim 1 wherein the bubble collector comprises:
a cylindrical shell having a length; and
a flange that projects radially outward from the cylindrical shell and restricts insertion of the bubble collector into the detection tube.

11. The apparatus of claim 10 wherein the length of the cylindrical shell and a position of the flange along the length of the cylindrical shell define an insertion depth that prevents the bubble collector from obstructing the optical path of the light source.

12. The apparatus of claim 1 wherein the bubble collector is transparent to the beam of light.

13. A method of monitoring a chemical dispensing system, the method comprising:
directing a beam of light so that an optical path of the beam of light passes through a detection tube;
modifying movement of bubbles in the detection tube using a bubble collector located in the detection tube so that the bubbles form a pocket of air in the optical path; and
determining the detection tube is in one of a product-available state or an out-of-product state based on an electrical signal output by a photodetector that is in the optical path when the detection tube is in one of the out-of-product state or the product-available state, and is not in the optical path when the detection tube is in the other of the out-of-product state or the product-available state.

14. The method of claim 13 wherein the bubble collector includes a torturous path through which a liquid carrying the bubbles passes.

15. The method of claim 13 wherein the bubble collector comprises:
a cylindrical shell having a length and including a bottom opening, a top opening offset from the bottom opening, and a side opening in a side of the cylindrical shell that is in the optical path.

16. The method of claim 15 wherein the bubble collector further comprises:
one or more chambers in the cylindrical shell that fluidically couple the bottom opening to the top opening; and
one or more partitions that project from an inner surface of the cylindrical shell, each partition defining an end of at least one of the one or more chambers.

17. The method of claim 16 wherein the one or more partitions include at least two partitions positioned sequentially along the length of the cylindrical shell, and the one or more chambers are located between the at least two partitions.

18. The method of claim 17 wherein the bubble collector further comprises one or more baffles each extending lengthwise from an edge of a respective one of the one or more partitions and having a length that leaves a gap between a distal end of the baffle and the partition adjacent to the partition from which the baffle extends.

19. The method of claim 18 wherein the edge of each partition defines an opening at one end of at least one of the one or more chambers, and each opening is rotationally offset from any adjacent openings so that the one or more partitions and the one or more baffles define a torturous path through the bubble collector.

20. The method of claim 13 wherein the bubble collector comprises:
a cylindrical shell having a length; and
a flange that projects radially outward from the cylindrical shell and restricts insertion of the bubble collector into the detection tube,
the length of the cylindrical shell and a position of the flange along the length of the cylindrical shell defining an insertion depth that prevents the bubble collector from obstructing the optical path of the beam of light.
